(19) United States
(12) Patent Application Publication
(10) Pub. No.: US 2025/0188944 A1
(43) Pub. Date: Jun. 12, 2025

(54) COMPRESSOR HOUSING, RADIAL COMPRESSOR WITH A COMPRESSOR HOUSING OF THIS TYPE, RADIAL COMPRESSOR ARRANGEMENT, EXHAUST GAS TURBOCHARGER AND INTERNAL COMBUSTION ENGINE

(71) Applicant: Rolls-Royce Solutions GmbH, Friedrichshafen (DE)

(72) Inventors: Johannes Kech, Ravensburg (DE); Tobias Männle, Ravensburg (DE)

(73) Assignee: Rolls-Royce Solutions GmbH, Friedrichshafen (DE)

(21) Appl. No.: 19/055,293

(22) Filed: Feb. 17, 2025

Related U.S. Application Data
(63) Continuation of application No. PCT/EP2023/071603, filed on Aug. 3, 2023.

(30) Foreign Application Priority Data
Aug. 17, 2022 (DE) 10 2022 120 820.6
Aug. 3, 2023 (WO) PCT/EP2023/071603

(51) Int. Cl. F04D 27/02; F04D 29/42

(52) U.S. Cl. CPC F04D 27/0215; F04D 27/0238; F04D 29/4206

(57) ABSTRACT

A compressor housing for a radial compressor includes: an accommodation chamber for a compressor impeller; an outflow region; a collecting cavity; a fluidic connection between the collecting cavity and the outflow region; and a valve device structured and arranged to change a flow cross-section of the fluidic connection between the collecting cavity and the outflow region.

### CROSS REFERENCE TO RELATED APPLICATIONS

This is a continuation of International patent application no. PCT/EP2023/071603, entitled “COMPRESSOR HOUSING, RADIAL COMPRESSOR WITH A COMPRESSOR HOUSING OF THIS TYPE, RADIAL COMPRESSOR ARRANGEMENT, EXHAUST GAS TURBOCHARGER AND INTERNAL COMBUSTION ENGINE”, filed Aug. 3, 2023, which is incorporated herein by reference. International patent application no. PCT/EP2023/071603 claims priority to German patent application no. 10 2022 120 820.6, filed Aug. 17, 2022, which is incorporated herein by reference.

### BACKGROUND OF THE INVENTION

### 1. Field of the Invention

The present invention relates to a compressor housing.

### 2. Description of the Related Art

Radial compressors of the type referenced here typically have a diffuser in which a flow velocity of the compressed fluid is reduced in favor of a pressure build-up. If a mass flow of the fluid in the diffuser decreases, flow instabilities and/or backflows may occur because an available flow channel is not fully utilized and a pressure gradient of the fluid acts against its flow direction. In such operating situations, compressor surges of the radial compressor can occur, resulting in that stable engine operation of an internal combustion engine having the radial compressor is not possible; in particular, certain operating ranges of the internal combustion engine are not drivable, and it is possible that operational targets for the internal combustion engine cannot be achieved. In particular, compressor surges can result in the performance of the internal combustion engine having to be reduced.

It is fundamentally possible to stabilize or shift the characteristic map of a radial compressor by way of measures such as recirculation of the pumped fluid. However, depending on the specific design, this can result in further disadvantages, particularly in those characteristic map ranges in which compressor surge is not typically a concern.

What is needed in the art is a compressor housing, a radial compressor having such a compressor housing, a radial compressor arrangement having such a radial compressor, an exhaust gas turbocharger with such a radial compressor arrangement or such a radial compressor, and an internal combustion engine with such an exhaust gas turbocharger, such a radial compressor arrangement or such a radial compressor, wherein the aforementioned disadvantages are at least reduced and optionally do not occur.

### SUMMARY OF THE INVENTION

The present invention relates to a compressor housing, a radial compressor having such a compressor housing, a radial compressor arrangement having such a radial compressor, an exhaust gas turbocharger with such a radial compressor arrangement or such a radial compressor, and an internal combustion engine with such an exhaust gas turbocharger, such a radial compressor arrangement or such a radial compressor.

The present invention provides a compressor housing for a radial compressor, which has an accommodation chamber for a compressor impeller, an outflow region and a collecting cavity, wherein the compressor housing also has a fluidic connection—in particular a fluidic return connection—between the collecting cavity and the outflow region and a valve device. The valve device is arranged and designed to change a flow cross-section of the fluidic connection between the collecting cavity and the outflow region. By way of the fluidic connection between the collecting cavity and the outflow region, a characteristic map of a radial compressor with the compressor housing can advantageously be expanded, shifted and/or stabilized, in particular to avoid a compressor surge. By way of the valve device, it is advantageously possible to carry out the corresponding change in the characteristic map only when and/or only to the extent when or to which compressor surge is actually a concern. If, however, the radial compressor is operated in characteristic map ranges in which no compressor surge occurs, the flow cross-section of the fluidic connection can be reduced—in particular to zero—so that at least essentially, optionally completely, the characteristic map that would exist without the fluidic connection is retained. This can reduce or avoid such disadvantages, in particular in those operating ranges that would otherwise be associated with the change in the characteristic map, in particular efficiency losses. In particular, recirculation invariably leads to efficiency losses and to a reduction in the pressure ratio across the radial compressor. This is however accepted in characteristic map ranges in which compressor surge is a threat, in particular in favor of stable engine operation without loss of performance. The possibility of switching off recirculation now advantageously avoids efficiency losses of the radial compressor in characteristic map ranges in which no compressor surge is a threat and thus the efficiency losses are not offset by other advantages, in particular at rated power of the internal combustion engine. The recirculation into the outflow region advantageously leads to a further improvement in the surge limit. Thus, the combination of the variable recirculation, which can be switched on and off, on the one hand, and the recirculation in the outflow region downstream of the compressor wheel, on the other hand, leads to a significantly improved characteristic map and stable, performance-optimized engine operation.

The fluidic connection between the collecting cavity and the outflow region is designed in particular such that, during operation of the radial compressor having the compressor housing, a gas flow can flow from the collecting cavity—in particular in a direction opposite to a main flow direction in the radial compressor—into the outflow region. In particular, the fluidic connection is a second fluidic connection between the collecting cavity and the outflow region formed in addition to a first fluidic connection formed along the main flow direction between the outflow region and the collecting cavity. In particular, the second fluidic connection is therefore also referred to as a fluidic return connection.

The outflow region is arranged in particular downstream of the compressor impeller.

In particular, the outflow region has at least one stationary guide vane, in particular a plurality of stationary guide vanes.

In particular, the collecting cavity is arranged downstream of the compressor impeller, in particular downstream of the outflow region. Alternatively, or in addition, the collecting cavity is part of a diffuser section of the compressor housing.

In one embodiment, the compressor housing includes the diffuser section, which in particular includes the outflow region and the collecting cavity or is formed by the outflow region and the collecting cavity.

The valve device is designed, in particular, to change the flow cross-section of the fluidic connection between the collecting cavity and the outflow region in a parameter-dependent manner, in other words, depending on at least one parameter.

The valve device is designed, in particular, to selectively interrupt or enable the fluidic connection, in particular depending on the parameters.

The valve device is designed, in particular, to completely enable or completely disable the fluidic connection, in particular in a parameter depending manner, or to release the fluidic connection gradually, in particular depending on parameters, in particular in discrete steps or continuously.

A further development of the present invention provides that the compressor housing has a first housing wall which limits the accommodation chamber, the outflow region and the collecting cavity at least partially, wherein at least one outflow bore leading into the collecting cavity is provided and at least one inflow bore leading into the outflow region is provided in the first housing wall, wherein the collecting cavity is fluidically connected to the outflow region via the at least one outflow bore and the at least one inflow bore. This housing design is compact, simple and cost-effective to produce.

In one embodiment, the first housing wall can be designed as a multi-component arrangement. In another embodiment, the first housing wall is a single component, in particular produced of a single material. In one embodiment, the first housing wall can be designed as a cast component or as part of a cast component.

In particular, the fluidic connection between the collecting cavity and the outflow region is established or formed via the at least one outflow bore and the at least one inflow bore. In particular, the at least one outflow bore is fluidically connected to the at least one inflow bore in such a way that during operation of the radial compressor including the compressor housing, the gas flow can flow from the collecting cavity into the outflow region via the at least one outflow bore and the at least one inflow bore.

A further development of the present invention provides that the compressor housing has an annular space into which the at least one outflow bore and the at least one inflow bore open, so that the collecting cavity is fluidically connected with the outflow region via the annular space. This represents a particularly compact design of the compressor housing.

The annular space encompasses in particular the accommodation chamber concentrically along a circumferential direction. In one embodiment, the annular space is a protective space or containment space provided for stabilization of the compressor housing or for protection, in particular of bystanders or adjacent systems in the event of destruction of the compressor impeller, in particular by bursting.

In the context of the present technical teaching, an axial direction is understood to mean in particular a direction that extends along an imaginary axis of rotation of the compressor impeller when the latter is arranged as intended in the compressor housing, in particular in the accommodation chamber. The circumferential direction encompasses the axial direction concentrically. A radial direction is perpendicular to the axial direction.

A further development of the present invention provides that the compressor housing has a second housing wall which connects a collecting cavity wall section of the first housing wall with an outflow region wall section of the first housing wall. This represents a particularly simple design to mechanically stabilize the compressor housing and to create the annular space.

The annular space is limited in particular—in particular completely—by the first housing wall on the one hand and by the second housing wall on the other hand.

In one embodiment the second housing wall can be designed as a multi-component arrangement. In another embodiment, the second housing wall is a single component, in particular produced of a single material. In one embodiment, the second housing wall can be designed as a single component, in particular produced of a single material, in particular of the same material as the first housing wall. In particular, in one embodiment the compressor housing can be designed as a cast component with the first housing wall and the second housing wall.

A further development of the present invention provides that the valve device is designed to selectively open and close at least one bore, selected from the outflow bore and the inflow bore. This represents a particularly simple and compact possibility to change the flow cross-section of the fluidic connection.

A further development of the present invention provides that the first housing wall includes a plurality of inflow bores leading into the outflow region. Thus, part of the fluid from the collecting cavity can be recirculated into the outflow region at high efficiency in order to change the compressor characteristic map.

In particular, the inflow bores are arranged at equal angular intervals along a circumference, in other words, in particular along the circumferential direction. This allows an especially uniform and efficient recirculation of a portion of the compressed fluid.

Alternatively, or in addition, it is possible that the first housing wall has a plurality of outflow bores leading into the collecting space, and in particular into the annular space. The outflow bores are arranged, in particular, distributed along the circumference, that is, in particular along the circumferential direction, at equal angular intervals.

The valve device is designed, in particular, to selectively open or close all outflow bores and/or all inflow bores simultaneously.

A further development of the present invention provides that the at least one inflow bore is nozzle-shaped. This allows a targeted and thus particularly efficient inflow of the recirculated fluid into the outflow region.

In one embodiment, the at least one nozzle-shaped inflow bore has an insert, in particular a nozzle insert, which is integrated or inserted into the first housing wall or which is designed as such an insert. In another embodiment, the at least one nozzle-shaped inflow bore is shaped or created by the first housing wall.

The present invention also provides a radial compressor which has a compressor housing according to the present invention or a compressor housing according to one or more of the previously described design examples. In connection with the radial compressor, advantages arise in particular which have already been explained above in connection with the compressor housing.

A further development of the present invention provides that a compressor impeller is arranged inside the accommodation chamber.

The compressor impeller has in particular at least one rotating guide vane, in particular a plurality of rotating guide vanes.

The present invention also provides a radial compressor arrangement which has a radial compressor according to the present invention or a radial compressor according to one or more of the previously described embodiments, as well as a control device which is operatively connected with the valve device and is designed to control the valve device. In connection with the radial compressor arrangement, advantages arise in particular which have already been explained above in connection with the compressor housing or the radial compressor.

The control device is arranged in particular to control the valve device in a parameter-dependent manner, that is, depending on at least one parameter. In this way, a change in the characteristic map of the radial compressor can be conducted with high flexibility, wherein the characteristic map can remain unchanged in particular if the radial compressor is operated in a characteristic map range in which there is no risk of compressor surge.

A further development of the present invention provides that the control device is arranged to control the valve device into an open position when an operating state of the radial compressor is in a predetermined characteristic map range arranged adjacent to a surge limit. In such a characteristic map range there is a risk in particular that compressor surging will occur, which is why it is advantageous if the valve device is controlled into the open position in order to release the fluidic connection.

In one embodiment, the control device is configured to control the valve device depending on the at least one parameter such that the fluidic connection is selectively completely enabled or completely disabled or is gradually—in particular in discrete steps—or continuously enabled.

The at least one parameter is in particular selected from a group consisting of: a pressure downstream of the radial compressor; a pressure loss across the radial compressor; a speed of the compressor impeller and a mass flow across the radial compressor. In particular, these parameters span a characteristic map of the radial compressor and are therefore suitable for evaluating the risk of compressor surge and, if necessary, for initiating appropriate countermeasures.

In one embodiment, the control device is arranged to enable or disable the fluidic connection depending on a comparison of the at least one parameter with an associated limit value.

In particular, the control device is operatively connected with at least one parameter sensor, which is arranged and equipped to detect the at least one parameter. The at least one parameter sensor is in particular selected from a group consisting of: a pressure sensor; a tachometer; and a mass flow sensor.

Alternatively, or in addition it is possible that the control device is arranged to calculate the at least one parameter or to determine it by simulation, or to receive the at least one parameter from another computing device, for example from the control unit of an internal combustion engine.

The present invention also provides an exhaust gas turbocharger which is equipped with an inventive radial compressor or a radial compressor according to one or a number of the previously described embodiments, or which has a radial compressor arrangement according to the present invention or a radial compressor arrangement according to one or a number of previously described embodiments. In connection with the exhaust gas turbocharger, advantages arise in particular that have already been explained previously in connection with the radial compressor arrangement, the radial compressor or the compressor housing.

The present invention also provides an internal combustion engine which has a radial compressor according to the present invention or a radial compressor according to one or a number of previously described embodiments, or which has a radial compressor arrangement according to the present invention or a radial compressor arrangement according to one or a number of the previously described embodiments, or which has an exhaust gas turbocharger according to the present invention or an exhaust gas turbocharger according to one or a number of the previously described embodiments. In connection with the internal combustion engine, advantages arise in particular that have already been explained previously in connection with the compressor housing, the radial compressor, the radial compressor arrangement or the exhaust gas turbocharger.

The present invention is explained in further detail below, with reference to the drawing. The single drawing shows a design example of an internal combustion engine with a design example of an exhaust gas turbocharger, a design example of a radial compressor arrangement, a design example of a radial compressor and a design example of a compressor housing.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a design example of an internal combustion engine, in accordance with an exemplary embodiment of the present invention.

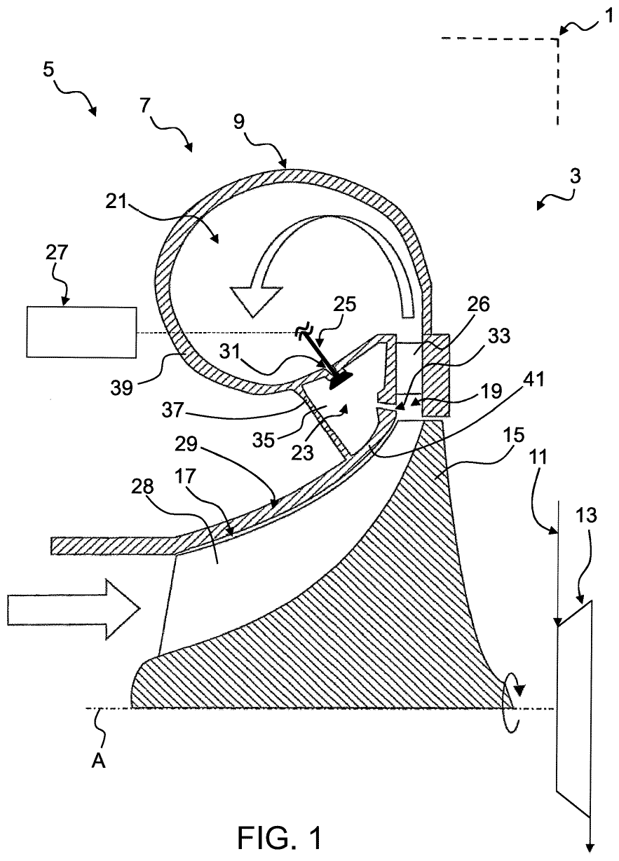

Corresponding reference characters indicate corresponding parts throughout the several views. The exemplification set out herein illustrates at least one embodiment of the invention, and such exemplification is not to be construed as limiting the scope of the invention in any manner.

### DETAILED DESCRIPTION OF THE INVENTION

The single drawing shows a design example of an internal combustion engine 1 with a design example of an exhaust gas turbocharger 3, a design example of a radial compressor arrangement 5, a design example of a radial compressor 7 and a design example of a compressor housing 9.

Exhaust gas turbocharger 3 has in particular a turbine 13 arranged in an exhaust gas path 11 of internal combustion engine 1, which is drive-connected to compressor impellor 15 of radial compressor 7.

Compressor housing 9 has an accommodation chamber 17 for compressor impeller 15, an outflow region 19 and a collecting cavity 21. In addition, compressor housing 9 has a fluidic connection 23 between collecting cavity 21 and outflow region 19 and a valve device 25, wherein valve device 25 is arranged and designed to change a flow cross-section of fluidic connection 23 between collecting cavity 21 and outflow region 19, in particular depending on parameters, in particular to selectively interrupt or enable fluidic connection 23.

At least one stationary guide vane 26 is arranged, in particular, in outflow region 19. Compressor impeller 15 has in particular at least one rotating guide vane 28.

Radial compressor arrangement 5 has a control device 27 which is operatively connected to valve device 25 and is designed to control valve device 25, in particular depending on at least one parameter. The at least one parameter is optionally selected from a group consisting of: a pressure downstream of radial compressor 7; a pressure loss across radial compressor 7; a rotational speed of compressor impeller 15; and a mass flow across radial compressor 7.

Control device 27 is designed in particular to control valve device 25 into an open position when an operating state of radial compressor 7 is in a predetermined characteristic map range arranged adjacent to a surge limit.

Compressor housing 9 has in particular, a first housing wall 29 which at least partially limits accommodation chamber 17, outflow region 19 and collecting cavity 21. At least one outflow bore 31 leading into collecting cavity 21 and at least one inflow bore 33 leading into outflow region 19 are provided in first housing wall 29, wherein collecting cavity 21 is fluidically connected with outflow region 19 via the at least one outflow bore 31 and the at least one inflow bore 33.

In particular, compressor housing 9 has an annular space 35 into which, on the one hand, the at least one outflow bore 31 and, on the other hand, the at least one inflow bore 33 open, so that collecting cavity 21 is fluidically connected with outflow region 19 via annular space 35.

In the design example illustrated here, compressor housing 9 has a second housing wall 37 which connects a collecting cavity wall section 39 of first housing wall 29 with an outflow region wall section 41 of first housing wall 29. Annular space 35 is limited, in particular on the one hand by first housing wall 29 and on the other hand by second housing wall 37.

Valve device 25 is designed, in particular, to selectively open and close at least one bore selected from outflow bore 31 and the inflow bore 33, here in particular outflow bore 31.

First housing wall 29 has, in particular, a plurality of inflow bores 33 leading into outflow region 19, which are optionally arranged distributed at equal angular intervals along a circumference around rotation axis A of compressor impeller 15. Alternatively, or in addition, first housing wall 29 has a plurality of outflow bores 31 leading into collecting chamber 21, which are optionally arranged distributed at equal angular intervals along the circumference around axis of rotation A of compressor impeller 15.

The at least one inflow bore 33 is optionally nozzle-shaped, wherein it is designed in particular integral with first housing wall 29, in particular formed by the latter, or in particular inserted into it as a nozzle insert.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A compressor housing for a radial compressor, the compressor housing comprising:
an accommodation chamber for a compressor impeller;
an outflow region;
a collecting cavity;
a fluidic connection between the collecting cavity and the outflow region; and
a valve device structured and arranged to change a flow cross-section of the fluidic connection between the collecting cavity and the outflow region.

2. The compressor housing according to claim 1, further including a first housing wall which limits the accommodation chamber, the outflow region, and the collecting cavity at least partially, the first housing wall including at least one outflow bore and at least one inflow bore, the at least one outflow bore leading into the collecting cavity, the at least one inflow bore leading into the outflow region, the collecting cavity being fluidically connected with the outflow region via the at least one outflow bore and the at least one inflow bore.

3. The compressor housing according to claim 2, further including an annular space into which the at least one outflow bore and the at least one inflow bore lead, such that the collecting cavity is fluidically connected with the outflow region via the annular space.

4. The compressor housing according to claim 3, wherein the first housing wall includes a collecting cavity wall section and an outflow region wall section, the compressor housing further including a second housing wall which connects the collecting cavity wall section of the first housing wall with the outflow region wall section of the first housing wall.

5. The compressor housing according to claim 4, wherein the annular space is limited by the first housing wall and the second housing wall.

6. The compressor housing according to claim 2, wherein the valve device is structured and arranged to selectively open and close the at least one outflow bore or the at least one inflow bore.

7. The compressor housing according to claim 2, wherein the first housing wall includes a plurality of the at least one inflow bore which lead into the outflow region and which are arranged at equal angular intervals circumferentially.

8. The compressor housing according to claim 2, wherein the at least one inflow bore is nozzle-shaped.

9. A radial compressor, comprising:
a compressor housing, which includes:
an accommodation chamber for a compressor impeller;
an outflow region;
a collecting cavity;
a fluidic connection between the collecting cavity and the outflow region; and
a valve device structured and arranged to change a flow cross-section of the fluidic connection between the collecting cavity and the outflow region.

10. The radial compressor according to claim 9, further including the compressor impeller, which is arranged in the accommodation chamber.

11. The radial compressor according to claim 10, wherein the compressor impeller includes at least one rotating guide vane, the compressor impeller and the at least one rotating guide vane being arranged in the accommodation chamber.

12. A radial compressor arrangement, comprising:
a radial compressor, including:
a compressor housing, which includes:
an accommodation chamber for a compressor impeller;
an outflow region;
a collecting cavity;
a fluidic connection between the collecting cavity and the outflow region; and
a valve device structured and arranged to change a flow cross-section of the fluidic connection between the collecting cavity and the outflow region; and
a control device, which is operatively connected with the valve device so as to control the valve device in a parameter-dependent manner.

13. The radial compressor arrangement according to claim 12, wherein the control device is structured and arranged to control the valve device into an open position when an operating state of the radial compressor is in a predetermined characteristic map range arranged adjacent to a surge limit.
